(19) United States
(12) Patent Application Publication
(10) Pub. No.: US 2024/0201952 A1
(43) Pub. Date: Jun. 20, 2024

(54) ARTIFICIAL INTELLIGENCE OPERATION SYSTEM AND METHOD THEREOF

(71) Applicant: ELECTRONICS AND TELECOMMUNICATIONS RESEARCH INSTITUTE, Daejeon (KR)

(72) Inventor: Hyunjeong KWON, Daejeon (KR)

(73) Assignee: ELECTRONICS AND TELECOMMUNICATIONS RESEARCH INSTITUTE, Daejeon (KR)

(21) Appl. No.: 18/393,565

(22) Filed: Dec. 21, 2023

(30) Foreign Application Priority Data
Dec. 19, 2022 (KR) 10-2022-0178719
Mar. 14, 2023 (KR) 10-2023-0033432

(51) Int. Cl. G06F 7/544; G06F 9/30

(52) U.S. Cl. CPC G06F 7/5443; G06F 9/3001

(57) ABSTRACT

Disclosed is an artificial intelligence (AI) operation system. The AI operation system includes a plurality of operators, and a host configured to merge nodes constituting a specific attention layer in a transformer model, pre-process specific matrix data among data of the merged node, distribute the preprocessed data and non-preprocessed data to the plurality of operators, and add and normalize operation results of the plurality of operators, wherein the plurality of operators perform a GEneral Matrix Matrix Multiplication (GEMM) operation in parallel using the distributed data.

### CROSS-REFERENCE TO RELATED APPLICATION

The present application claims priority under 35 U.S.C. §119(a) to Korean Application No. 10-2022-0178719, filed on Dec. 19, 2022 in the Korean Intellectual Property Office and Korean Application No. 10-2023-0033432 filed on Mar. 14, 2023 in the Korean Intellectual Property Office, which are hereby incorporated by reference for all purposes as if set forth herein.

### BACKGROUND

### 1. Field of the Invention

The present invention relates to an artificial intelligence (AI) operation system and method, and more particularly, to an AI operation system and method that can increase the hourly resource usage of a systolic array-based operator.

### 2. Discussion of Related Art

A transformer model based on self-attention operation is a model that has been successfully applied not only to sequence-based applications such as text and speech, where it was initially applied, but also to various vision and speech-based application situations recently. The scope of application of the transformer model has gradually expanded, and the size of the transformer model has also increased, and thus, there is a growing need for accelerating operations in the transformer model.

However, when accelerating transformer model inference in a systolic array, there is a disadvantage in that operation resource usage is reduced due to GEneral Matrix Vector Multiplication (GEMV) operation.

### SUMMARY OF THE INVENTION

The present invention is directed to providing an artificial intelligence (AI) operation system and method that can increase the hourly resource usage of a systolic array-based operator.

According to an aspect of the present invention, there is provided an AI operation system including a plurality of operators, and a host configured to merge nodes constituting a specific attention layer in a transformer model, pre-process specific matrix data among data of the merged node, distribute the preprocessed data and non-preprocessed data to the plurality of operators, and add and normalize operation results of the plurality of operators, wherein the plurality of operators may perform a GEneral Matrix Matrix Multiplication (GEMM) operation in parallel using the distributed data.

In some embodiments of the present invention, the host may merge the nodes constituting the attention layer consisting of GEneral Matrix Vector Multiplication (GEMV), Softmax, and GEMV into a single node.

In some embodiments of the present invention, the data of the merged node may include at least one of query feature map data, key feature map data, and value feature map data.

In some embodiments of the present invention, the host may preprocess the value feature map data among the data of the merged node.

In some embodiments of the present invention, the host may perform a logarithmic operation on each element of the value feature map data, and perform preprocessing by dividing a value obtained by performing the logarithmic operation by a sum of each element of the query feature map data.

In some embodiments of the present invention, the AI operation system may further include a memory, wherein the host may store the preprocessed data and the non-preprocessed data in the memory and extract data necessary for each operator from the memory and distribute the extracted data.

In some embodiments of the present invention, the host may divide a new operation generated by merging the nodes into independent operations, distribute the divided operations to the plurality of operators, and distribute data necessary for an operation to be performed by each operator among the preprocessed data and the non-preprocessed data, to each operator.

In some embodiments of the present invention, each of the plurality of operators may include an internal memory storing the distributed data, a processing element array including a plurality of processing elements, and a controller controlling the operation of the processing element and data movement between the processing elements in response to a request from the host.

In some embodiments of the present invention, the plurality of processing elements may include a plurality of adders receiving row-direction data and column-direction data among the data stored in the internal memory through the controller and adding the received data, a plurality of multipliers receiving the row-direction data among the data stored in the internal memory through the controller and multiplying the row-direction data by output values of the plurality of adders, and a plurality of exponent operators and multipliers performing an exponent operation on an output value of the plurality of multipliers and performing a cumulative multiplication operation on exponent output values.

In some embodiments of the present invention, each of the plurality of exponent operators and multipliers may include a lookup table outputting an exponent for the output value of each multiplier.

In some embodiments of the present invention, the processing element array may be based on a systolic array.

According to another aspect of the present invention, there is provided an AI operation system comprising a plurality of operators, a host configured to merge nodes constituting a specific attention layer in a transformer model, preprocess specific matrix data among data of the merged nodes to convert GEMV into GEMM, distribute the preprocessed data and non-preprocessed data to the plurality of operators to perform GEMM in parallel in the plurality of operators, and add and normalize operation results of the plurality of operators, and a memory configured to store the preprocessed data and the non-preprocessed data, wherein each of the plurality of operators may receive row/column-direction data based on the distributed data and perform an addition operation, receive row-direction data based on the distributed data and perform a multiplication operation on the received row-direction data and a value obtained by performing the addition operation and the multiplication operation, perform an exponent operation on a value obtained by performing the multiplication operation, and perform a GEMM operation in parallel by performing a cumulative multiplication operation on values obtained by performing the exponent operation.

In some embodiments of the present invention, the host may merge the nodes constituting the attention layer consisting of GEMV, Softmax, and GEMV into a single node.

In some embodiments of the present invention, the data of the merged node may include at least one of query feature map data, key feature map data, and value feature map data, and the host may perform a logarithmic operation on each element of the value feature map data among the data of the merged node, and perform preprocessing by dividing a value obtained by performing the logarithmic operation by a sum of each element of the query feature map data.

In some embodiments of the present invention, each of the plurality of operators may include an inner memory storing the distributed data, a processing element array including a plurality of processing elements, and a controller controlling the operation of the processing element and data movement between the processing elements in response to a request from the host.

In some embodiments of the present invention, the plurality of processing elements may include a plurality of adders receiving row-direction data and column-direction data among the data stored in the internal memory through the controller and adding the received data, a plurality of multipliers receiving the row-direction data among the data stored in the internal memory through the controller and multiplying the row-direction data by output values of the plurality of adders, and a plurality of exponent operators and multipliers performing an exponent operation on an output value of the plurality of multipliers and performing a cumulative multiplication operation on exponent output values.

According to still another aspect of the present invention, there is provided an AI operation method comprising: merging, by a host, nodes constituting a specific attention layer in a transformer model, preprocessing, by the host, specific matrix data among data of the merged node, distributing, by the host, the preprocessed data and non-preprocessed data to a plurality of operators, performing, by the plurality of operators, a parallel operation using the distributed data, and adding and normalizing, by the host, operation results of the plurality of operators.

In some embodiments of the present invention, the merging of the nodes may include merging, by the host, the nodes constituting the attention layer consisting of GEMV, Softmax, and GEMV into a single node.

In some embodiments of the present invention, the preprocessing of the specific matrix data may include performing, by the host, a logarithmic operation on each element of value feature map data among data of the merged node including at least one of query feature map data, key feature map data, and the value feature map data and perform preprocessing by dividing a value obtained by performing the logarithmic operation by a sum of each element of the query feature map data.

In some embodiments of the present invention, the performing of the parallel operation may include storing, by a controller of each operator, the distributed data in an inner memory, receiving, by a plurality of adders of each operator, row-direction data and column-direction data among the data stored in the internal memory through the controller and adding the received data, receiving, by a plurality of multiplexers of each operator, the row-direction data among the data stored in the internal memory through the controller and multiplexing the row-direction data by output values of the plurality of adders, and performing, by a plurality of exponent operators and multipliers of each operator, an exponent operation on output values of the plurality of multiplexers and performing a cumulative multiplication operation on exponent output values.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an exemplary diagram illustrating a conventional attention layer consisting of Matmul, Softmax, and Matmul;

FIG. 2 is a block diagram illustrating an artificial intelligence (AI) operation system according to an embodiment of the present invention;

FIG. 3 is an exemplary diagram illustrating merging of nodes constituting an attention layer consisting of GEMV, Softmax, and GEMV according to an embodiment of the present invention;

FIG. 4 is an exemplary diagram illustrating conventional GEMV, Softmax, and GEMV operation;

FIG. 5 is an exemplary diagram illustrating preprocessing of matrix data according to an embodiment of the present invention;

FIG. 6 is a diagram illustrating an operator according to an embodiment of the present invention;

FIG. 7 is a diagram illustrating the configuration of a processing element according to an embodiment of the present invention;

FIGS. 8 and 9 are exemplary diagrams illustrating a method of performing a GEMM operation in parallel in a plurality of operators according to an embodiment of the present invention;

FIG. 10 is an exemplary diagram illustrating a method of adding and normalizing operation results of a plurality of operators according to an embodiment of the present invention;

FIG. 11 is a diagram illustrating an AI operation method according to an embodiment of the present invention; and

FIG. 12 is a flowchart illustrating a GEMM operation method of an operator according to an embodiment of the present invention.

### DETAILED DESCRIPTION OF EXEMPLARY EMBODIMENTS

Hereinafter, an artificial intelligence (AI) operation system and method according to an embodiment of the present invention will be described in detail with reference to the accompanying drawings. It should be noted that the drawings are not to precise scale and may be exaggerated in thickness of lines or sizes of components for descriptive convenience and clarity only. In addition, terms to be described below as terms which are defined in consideration of functions in the present invention may vary depending on the intention of a user or an operator or usual practice. Accordingly, the terms need to be defined based on contents throughout this specification.

The development trend of deep learning models is changing from previous convolution-based models and recurrent neural network-based models to transformer models. The transformer model is based on an attention layer and is one of the models in which the need for acceleration is very large due to the significantly large size of the model.

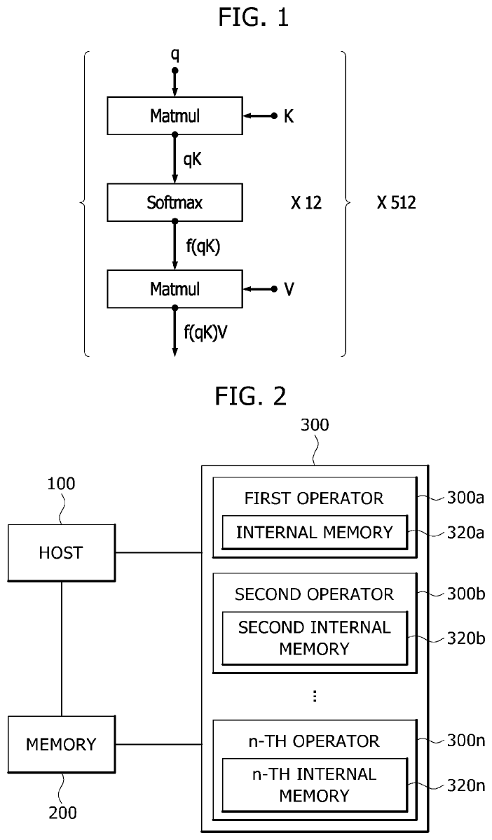

There are various transformer models, such as Bidirectional Encoder Representations from Transformers (BERT) and Generative PretrainedTransformer (GPT). Among the transformer models, a GPT2 model has an attention layer consisting of Matmul, Softmax, and Matmul repeated 12 times, as illustrated in FIG. 1A, and this causes 512 operations to be repeated. Due to the unique operation characteristics of the attention layer, the Matmul operator is GEneral Matrix Matrix multiplication (GEMM), which is the multiplication of a matrix and a matrix in the first operation among the 512 operations, but the remaining 511 operations are GEneral Matrix Vector multiplication (GEMV) operations, which are the multiplication of a vector and a matrix.

When these GEMV operations are processed in a systolic array, that is, a traditional NPU structure, the resource usage per hour is low, which is a factor that impairs the effectiveness of acceleration. As illustrated in FIG. 1B, unlike matrices, vectors supply data to a portion of the operator, so the resource usage is significantly low, which reduces the amount of operations that can be processed per hour.

Accordingly, the present invention proposes a technology to increase the acceleration effect by increasing the resource usage per hour when accelerating a transformer model in a systolic array by reconfiguring the attention layer of the transformer model.

The present invention proposes a method of reconstructing an attention layer of a transformer model and distributing data to solve the technical problem of reduced operation resource usage due to GEMV operation when accelerating transformer model inference in a systolic array, thereby increasing operation efficiency.

The present invention relates to technology for reconstructing an attention layer and distributing data to the internal memory 320 of the operator to efficiently drive the attention layer, which forms the basis of a transformer model that can be applied to various application systems based on text, image, and speech, in a systolic array-based accelerator.

The present invention relates to a method for efficiently operating an attention layer of a transformer model consisting of GEMV (multiplication of matrix and vector), Softmax, and GEMV.

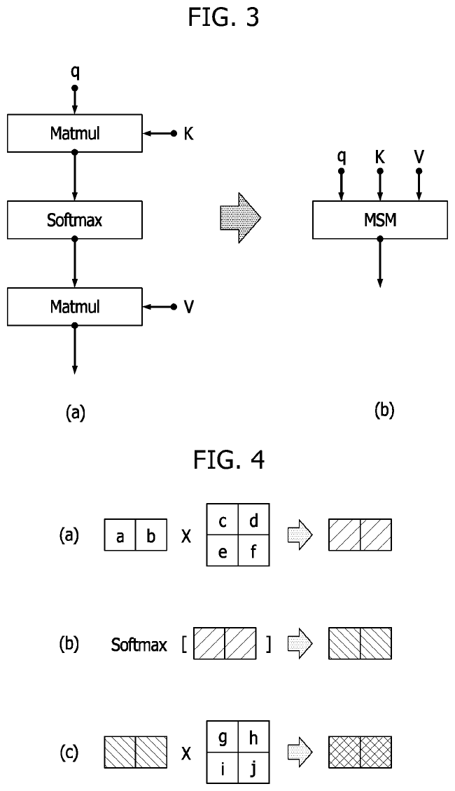

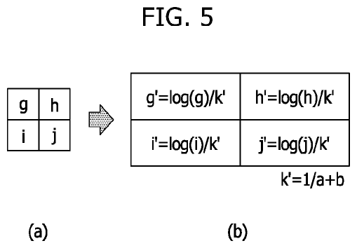

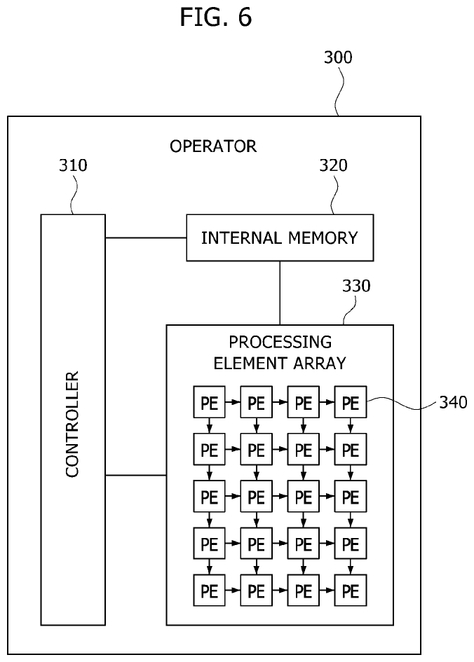

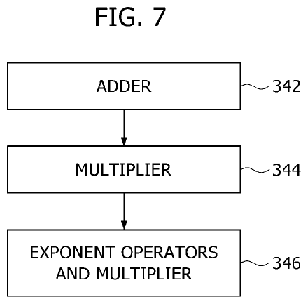

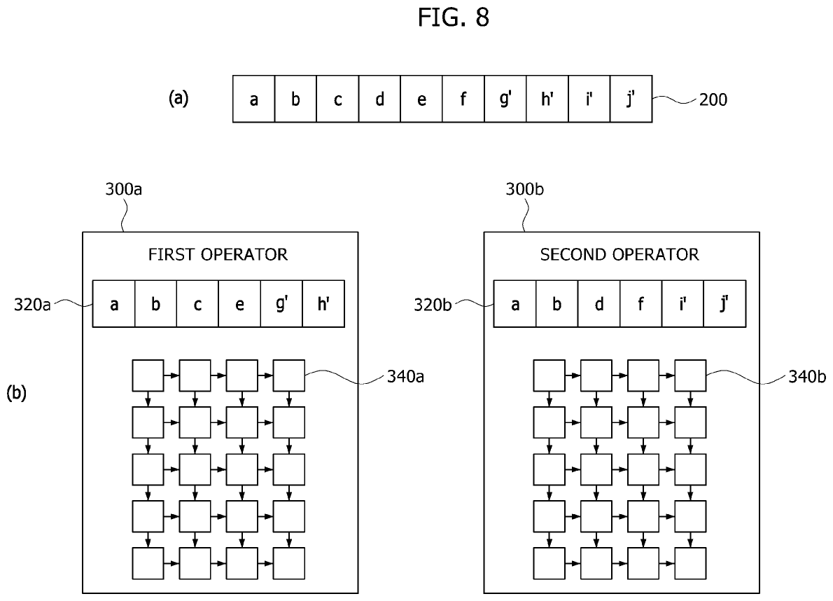

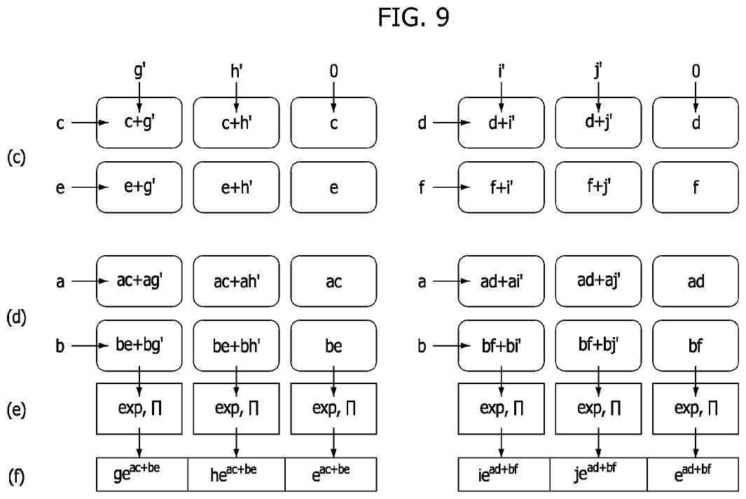

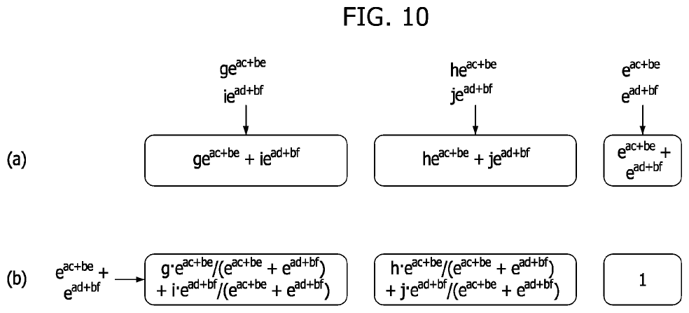

FIG. 2 is a block diagram illustrating an artificial intelligence (AI) operation system according to an embodiment of the present invention, FIG. 3 is an exemplary diagram illustrating merging of nodes constituting an attention layer consisting of GEMV, Softmax, and GEMV according to an embodiment of the present invention, FIG. 4 is an exemplary diagram illustrating conventional GEMV, Softmax, and GEMV operation, FIG. 5 is an exemplary diagram illustrating preprocessing of matrix data according to an embodiment of the present invention, FIG. 6 is a diagram illustrating an operator according to an embodiment of the present invention, FIG. 7 is a diagram illustrating the configuration of a processing element according to an embodiment of the present invention, FIGS. 8 and 9 are exemplary diagrams illustrating a method of performing a GEMM operation in parallel in a plurality of operators according to an embodiment of the present invention, and FIG. 10 is an exemplary diagram illustrating a method of adding and normalizing operation results of a plurality of operators according to an embodiment of the present invention.

Referring to FIG. 2, an artificial intelligence (AI) operation system according to an embodiment of the present invention includes a host 100, a memory 200, and a plurality of operators 300a, 300b, . . . , and 300n (hereinafter referred to as “300”).

The host 100 may control the overall operation of the AI operation system. For example, the host 100 may control the plurality of operators 300 by providing commands and data.

The host 100 may merge nodes constituting a specific attention layer in a transformer model, preprocess specific matrix data among data of the merged node, distribute the preprocessed data and non-preprocessed data to the plurality of operators 300, and add and normalize operation results of the plurality of operators 300.

Hereinafter, the operation of the host 100 will be described in detail.

The host 100 may merge nodes constituting an attention layer consisting of GEMV, Softmax, and GEMV in a transformer model into a single node. Here, data of the merged node may include query feature map (q), key feature map (K), and value feature map (V).

That is, the host 100 may first read the transformer model and perform a lowering operation while gradually simplifying a transformer model graph. For example, the host 100 may gradually simplify the graph by deleting unnecessary nodes and merging multiple nodes that can be operated at once. At this time, when it is confirmed that GEMV, Softmax, and GEMV exist in the model graph, the host 100 may merge GEMV, Softmax, and GEMV into a single node, and generate an operator MSM with a new name that accepts the same input and outputs the same output.

In this manner, the host 100 may merge the plurality of nodes to generate an operator with a new name that accepts the same input and outputs the same output. That is, the host 100 may merge the nodes constituting the attention layer consisting of GEMV, Softmax, and GEMV as shown in FIG. 3A, and generate the operator with the new name that accepts the same input and outputs the same output as shown in FIG. 3B. Next, the lower end of a compiler (not shown) of the host 100 may read MSM instead of GEMV, Softmax, and GEMV, and output an operation suitable for MSM.

For example, as shown in FIG. 3A, a case where Matmul (first GEMV), Softmax, and Matmul (second GEMV) operations are sequentially performed will be described. At this time, it is assumed that query feature map data (q) is a and b, key feature map data (K) is c, d, e, and f, and value feature map data (V) are g, h, i, and j. The first GEMV operation may be performed as shown in FIG. 4A, and each element of a first GEMV operation result vector may be ac+be and ad+bf. The Softmax operation may be performed as shown in FIG. 4B, and each element of a Softmax operation result vector is e^{ac+be}/(e^{ac+be}+e^{ad+bf}) and e^{ad+bf}/(e^{ac+be}+e^{ad+bf}). The second GEMV operation may be performed as shown in FIG. 4C, and each element of a second GEMV operation result vector is g. e^{ac+be}/(e^{ac+be}+e^{ad+bf})+i.e^{ad+bf}/(e^{ac+be}+e^{ad+bf}) and h.e^{ac+be}/(e^{ac+be}+e^{ad+bf})+j.e^{ad+bf}/(eactbe +e^{ad+bf}). In this way, performing the GEMV operation, Softmax operation, and GEMV operation sequentially is inefficient in terms of resource usage of the operator 300 when performing the operations in the systolic array-based operator 300.

Accordingly, the present invention may increase the resource usage per hour of the systolic array by merging three nodes of the GEMV operation, Softmax operation, and GEMV operation and converting GEMV operation into GEMM operation. To this end, the host 100 may merge the nodes constituting the attention layer consisting of the GEMV operation, the Softmax operation, and the GEMV operation.

Next, the host 100 may preprocess matrix data required to convert the GEMV operation into GEMM. At this time, the host 100 may preprocess the value feature map data (V) among the data of the merged node. That is, the host 100 may perform preprocessing by performing a logarithmical operation on each element of the value feature map data (V) and dividing a value obtained by performing the logarithmical operation by a sum of each element of the query feature map data (q).

For example, as shown in FIG. 5, the host 100 may preprocess the value feature map data (V). That is, the host 100 may perform a logarithmic operation on g, h, i, and j, which are the value feature map data (V), and acquire log(g), log(h), log(i), and log(j). Next, the host 100 may divide each of log(g), log(h), log(i), and log(j) by a sum (k′=1/a+b) of a and b, which are the query feature map data (q), and acquire the preprocessed matrix data such as g′=log(g)/k′, h′=log(h)/k′, i′=log(i)/k′, j′=log(j)/k′.

In this way, the host 100 may not use only the value feature map data (V) as is, but may preprocess the value feature map data (V) among the data of the merged node including the query feature map data (q), the key feature map data (K), and the value feature map data (V), and transmit the preprocessed data to the operator 300. The host 100 may use the query feature map data (q) and key feature map data (K) as is without preprocessing them.

When preprocessing of specific matrix data is completed, the host 100 may store the preprocessed data and the non-preprocessed data in the memory 200, and extract data necessary for each operator 300 from the memory 200 and distribute the extracted data. That is, the host 100 may divide a new operation (MSM) generated through the merging of the nodes into operations that are not dependent on each other, distribute the divided operations to each operator 300, and distribute data necessary for an operation to be performed in each operator 300 among the preprocessed data and the non-processed data to each operator 300. In other words, the host 100 may distribute, to the operator 300, the data necessary for the operation to be performed in each operator 300 among the query feature map data (q), the key the feature map data (K), and the preprocessed value feature map data (V′).

The host 100 may divide the merged operation (MSM) generated by merging the nodes into operations that are not dependent on each other, and allow each operation to be performed independently in each operator 300. At this time, the data necessary for the operation may vary depending on the operation performed by each operator 300. Accordingly, the host 100 may store the preprocessed data and the non-preprocessed data in the memory 200 and distribute elements necessary for each operator 300.

In addition, the host 100 may add the operation results of the plurality of operators 300 and then normalize them. When normalization is performed, the host 100 may acquire the same operation result as the result of sequentially performing GEMV, Softmax, and Since the normalization method is the same as the conventional GEMV operations. method, description thereof will be omitted.

The memory 200 may store data that has been preprocessed and data that has not been preprocessed by the host 100. That is, the memory 200 may store the query feature map data (q), the key feature map data (K), and the preprocessed value feature map data (V′).

The memory 200 may record or read data under the control of the host 100. For example, the memory 200 may write data in response to a command and an address provided from the host 100, or provide the read data to the operator 300.

Such a memory 200 may be either a volatile memory in which data is lost when power is turned off, such as DRAM or SRAM, or a nonvolatile memory in which data is retained even when power is turned off, such as flash memory, PRAM, ReRAM, MRAM, or FRAM.

The plurality of operators 300 may load the data distributed from the host 100 into the internal memory 320 and perform a parallel operation using the distributed data. At this time, the plurality of operators 300 may perform the GEMM operation in parallel using the distributed data.

Each operator 300 may receive row-direction data and column-direction data to perform an addition operation, receive the row-direction data to perform a multiplication operation on the received data and a value obtained by performing the addition operation, perform an exponent operation on a value obtained by performing the multiplication operation, perform a cumulative multiplication operation on values obtained by performing the exponent operation, and then store the resultant value.

Such an operator 300 may include an internal memory 320, a controller 310, and a processing element array 330, as shown in FIG. 6.

The data distributed by the host may be stored in the internal memory 320.

The controller 310 may control the operation of the internal memory 320 and the processing element array 330.

In addition, the controller 310 may control the operation of the processing elements 340 and data movement between the processing elements 340 in response to a plurality of operation modes. The controller 310 may control the processing elements 340 through a control path.

The processing element array 330 may include a plurality of processing elements PE 340. The processing element array 330 may have a systolic array structure.

The plurality of processing elements PE 340 may be connected in an array form, and perform operations by exchanging data between neighboring processing elements PE 340. Input data may be data distributed by the host 100 and stored in the internal memory 320. Each processing element PE 340 may receive input data and transmit the input data to the neighboring processing elements PE 340. The processing element PE 340 may transmit the input data in the row direction of the processing element array 330. Alternatively, the processing element PE 340 may transmit the input data in the column direction of the processing element array 330. In this way, the processing element PE 340 may sequentially transmit the input data in a specific direction (e.g., at least one of the row and column directions). The processing element PE 340 may perform an operation based on the input data transmitted from the internal memory 320 or another processing element PE 340.

The processing element 340 may perform a operation based on the input data provided from the internal memory 320 under the control of the controller 310. For example, the processing element 340 may perform an addition operation, a multiplication operation, an exponent operation, etc., based on the input data.

The plurality of processing elements 340 may include a plurality of adders 342, a plurality of multipliers 344, a plurality of accumulators (not shown), and a plurality of exponent operators and multipliers 346, as shown in FIG. 7. Here, the plurality of exponent operators and multipliers 346 may be located at the ends of the processing element array 330 in the row and column directions, and perform an exponent operation and a cumulative multiplication operation.

Each adder 342 may receive row-direction data and column-direction data among the data stored in the internal memory 320 through the controller 310, and perform an addition operation on the input row-direction data and column-direction data. At this time, the row-direction data and column-direction data may be data (values) selected according to an operation method predetermined during a design of a compiler.

The host 100 may read an operator and execute a compiler that outputs an instruction to be transmitted to the operator 300. At this time, depending on an instruction generated by the compiler, values to be input to the row-direction data and column-direction data may vary. Accordingly, the row-direction data and column-direction data input to each adder 342 may be selected according to a predetermined operation method when designing the compiler. At this time, since the result of the operation is the same even if the directions of the row-direction data and column-direction data is changed, the directions of the row data and column data input to the operator 300 do not need to be considered. In addition, the selection of the row-direction data and column-direction data may be the result of a pre-designed compiler. When designing the compiler, to identically output the results of sequentially operating GEMV, Softmax, and GEMV in advance and the result of the MSM operation that merges them, the order in which operations should be performed may be determined at the time of designing the compiler. Accordingly, the row-direction data and column-direction data input to each adder 342 may be values arranged according to a predetermined operation method.

Each multiplier 344 may receive the row-direction data from among the data stored in the internal memory 320 through the controller 310, and multiply the received row-direction data by the output value of each adder 342. At this time, the input row-direction data may be data (value) selected according to an operation method predetermined during the design of the compiler. The same result can be obtained even by inputting the row-direction data in the column direction.

Each exponent operator and multiplier 346 may output an exponent for the output value of each multiplier 344, and may perform a cumulative multiplication operation on the exponent output values. That is, since each exponent operation and multiplier 346 includes a lookup table that outputs an exponent for the output value of each multiplier 344, an exponent operation may be performed on the output value of each multiplier 344.

Each accumulator may store the output value of each exponential operation and multiplier 346.

For example, when the operator 300 is composed of a first operator 300a and a second operator 300b as shown in FIGS. 8 and 9, a method of processing a GEMM operation in parallel will be described.

When data is stored in the memory 200 as shown in (a) of FIG. 8, the host 100 may distribute data a, b, c, e, g′, and h′ to the first operator 300a, and distribute data a, b, d, f, i′, and j′ to the operator 300b. That is, q, which is a vector composed of a and b, may be distributed and used in both the first operator 300a and the second operator 300b, and the first columns c and e in matrix K composed of c, d, e, and f may be distributed to the operator 300a, and the second columns d and f may be distributed to the second operator 300b. In the same manner, in matrix V′ composed of preprocessed g′, h′, i′, and j′, the first rows g′ and h′ may be distributed to the first operator 300a, and the second rows i′ and j′ may be distributed to the second operator 300b.

Next, as shown in (b) of FIG. 8, the data a, b, c, e, g′, and h′ may be stored in a first internal memory 320a of the first operator 300a, and the data a, b, d, f, i′, and j′ may be stored in a second internal memory 320b of the second operator 300b.

A first controller 310a of the first operator 300a may input row and column-direction data c, e, g′, h′, and 0 from the data stored in the first internal memory 320a to the plurality of adders 342a. Next, each adder 342a of the first operator 300a may add the row-direction data c and e and the column-direction data g′, h′, and 0 as shown in (c) of FIG. 9. In addition, the second controller 310b of the second operator 300b may input the row- and column-direction data d, f, i′, j′, and 0 from the data stored in the second internal memory 320b to the plurality of adders 342b. Next, each adder 342b of the second operator 300b may add the row-direction data d and f and the column-direction data i′, j′, and 0 as shown in (c) of FIG. 9.

The output value of each adder 342a or 342b of the first operator 300a and the second operator 300b may be input as the column-direction data the multipliers 344a and 344b of of the first operator 300a and the second operator 300b. The multipliers 344a and 344b of the first operator 300a and the second operator 300b may receive the row-direction data among the data stored in the first internal memory 320a and the second internal memory 320b by the first controller 310a and the second controller 310b. Next, the multipliers 344a and 344b of the first operator 300a and the second operator 300b may multiply the input row-direction data and column-direction data. For example, output values c+g′, c+h′, c, e+g′, eth′, and e of each adder 342a of the first operator 300a may be input as the column-direction data of the multiplier 344b of the first operator 300a, and specific data a and b among the data stored in the first internal memory 320a may be input as the row-direction data of the multiplier 344a of the first operator 300a. Next, each multiplier 344a of the first operator 300a may multiply the row-direction data a and b and the column-direction data c+g′, c+h′, c, e+g′, eth′, and e as shown in (d) of FIG. 9. Next, each multiplier 344a of the first operator 300a may output ac+ag′, ac+ah′, ac, betbg′, be+bh′, and be.

In addition, output values d+i′, d+j′, d, f+i′, f+j′, and f of each adder 342b of the second operator 300b may be input as the row-direction data of the multiplier 344b of the second operator 300b, and specific data a and b among the data stored in the second internal memory 320b may be input as the row-direction data of the multiplier 344b of the second operator 300b. Next, each multiplier 344b of the second operator 300b may multiply the row-direction data a and b and the column-direction data d+i′, d+j′, d, f+i′, f+j′, and f as shown in (d) of FIG. 9. Next, each multiplier 344b of the second operator 300b may output ad+ai′, ad+aj′, ad, bf+bi′, bf+bj′, and bf.

The output values of the multipliers 344a and 344b of the first and second operators 300a and 300b may be input to the exponent operation and multipliers 346a and 346b of the first and second operators 300a and 300b, respectively. Next, the exponent operation and multipliers 346a and 346b of the first operator 300a and the second operator 300b may output exponents for the input output values of the multipliers 344a and 344b, and perform a cumulative multiplication operation on the output exponents.

For example, as shown in (e) of FIG. 9, when the output values ac+ag′, ac+ah′, ac, be+bg′, be+bh′, and be of the multiplier 344a of the first operator 300a are input to the exponent operation and multiplier 346a of the first operator 300a, the exponent operator and multiplier 346a of the first operator 300a may output ge^{ac+be}, he^{ac+be}, and e^{ac+be}Specifically, ac+ag′ and be+bg′, which are the output values of the multiplier 344a of the first operator 300a, may be sequentially input to the exponent operator and multiplier 346a located at the lower end of the processing element array 330. After be+bg′ is input and e^{be+bg′} is operated and stored, ac+ag′ may be input and e^{ac+ag′} may be operated, and e^{be+bg} and ac+ag′ may be subjected to a cumulative multiplication operation to output e^{ac+ag′}x e^{be+bg′} as shown in (f) of FIG. 9. e^{ac+ag′}x e^{be+bg′} may be the same as ge^{ac+be}

In addition, when ad+ai′, ad+aj′, ad, bf+bi′, bf+bj′, and bf which are output values of the multiplier 344 of the second operator 300b are input to the exponent operation and multiplier 346b of the second operator 300b, the exponent operation and multiplier 346b of the second operator 300b may output ie^{ad+bf}, je^{ad+bf}, and e^{ad+bf}. Since the exponent operation and multiplier 346b of the second operator 300b is the same as the exponent operation and multiplier 346a of the first operator 300a, detailed description thereof will be omitted.

When the operations of the first operator 300a and the second operator 300b are completed, the host 100 may add and normalize the operation results of the first operator 300a and the second operator 300b. For example, the host 100 may add ge^{ac+be}, he^{ac+be}and e^{ac+be}, which are the operation results of the first operator 300a shown in (f) of FIG. 9, and ie^{ad+bf}, je^{ad+bf}, and e^{ad+bf}, which are the operation results of the second operator 300b, respectively. That is, as shown (a) in FIG. 10, the host 100 may add ge^{ac+be} and ie^{ad+bf}, add he^{ac+be} and je^{ad+bf}, and add e^{ac+be} and e^{ad+bf}. Next, the host 100 may perform normalization on the added results. Next, as shown (b) in FIG. 10, the host 100 may output g. e^{ac+be}/(e^{ac+be}+e^{ad+bf}) +i. e^{ad+bf}/(e^{ac+be}+e^{ad+bf}) and h. eastbe/(eastbe +e^{ad+bf}) +j. e^{ad+bf}/(e^{ac+be}+e^{ad+bf}). These operation results may be the same as the results of performing the GEMV, Softmax, and GEMV operations in order.

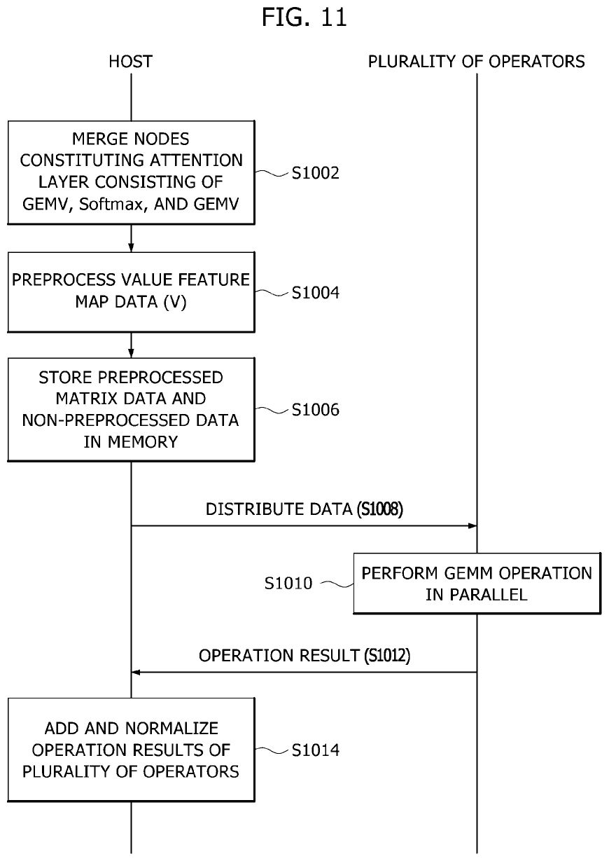

FIG. 11 is a diagram illustrating an AI operation method according to an embodiment of the present invention.

Referring to FIG. 11, in operation S1002, the host 100 may merge nodes constituting an attention layer consisting of GEMV, Softmax, and GEMV in a transformer model, into a signal node. The host 100 may merge GEMV, Softmax, and GEMV into a single node, and generate an operator MSM with a new name that accepts the same input and outputs the same output. At this time, data of the merged node may include query feature map data (q), key feature map data (K), and value feature map data (V).

After operation S1002, the host 100 may preprocess the value feature map data (V) among the data of the merged node (operation S1004). That is, the host 100 may perform preprocessing by performing a logarithmical operation on each element of the value feature map data (V) and dividing a value obtained by performing the logarithmical operation by a sum of each element of the query feature map data (q).

After operation S1004, the host 100 may store the preprocessed data and non-preprocessed data in the memory 200 (operation S1006), and extract data required by each operator 300 from the memory 200 and distribute the extracted data (operation S1008). That is, the host 100 may divide the new operation (MSM) generated by merging the nodes into operations that are not dependent on each other, distribute the divided operations to each operator 300, and distribute data required for an operation to be performed in each operator 300 among the preprocessed data and the non-preprocessed data, to each operator 300. In other words, the host 100 may distribute the data required for the operation to be performed in each operator 300 among the query feature map data (q), the key feature map data (K), and the preprocessed value feature map data (V′), to each operator 300.

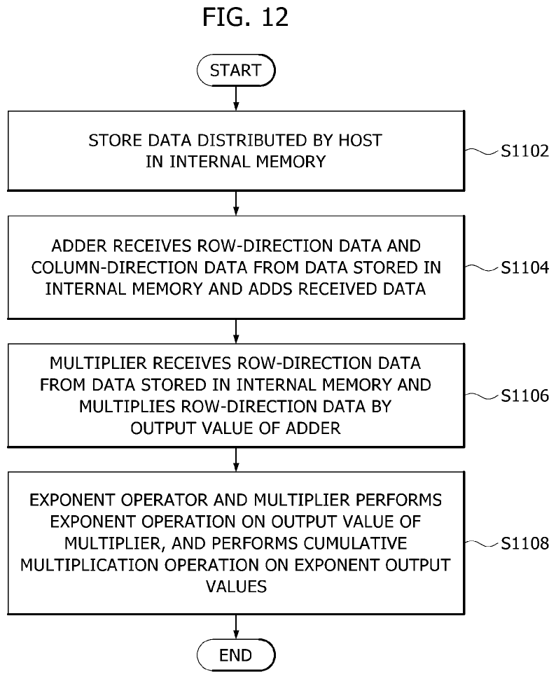

After operation S1008, each of the plurality of operators 300 performs a GEMM operation in parallel using the data distributed by the host 100 (operation S1010). A method for the operator 300 to perform a GEMM operation will be described with reference to FIG. 12.

After operation S1010, the host 100 receives operation results of the plurality of operators 300 (operation S1012), add the operation results of each operator 300, and then normalize the added results (operation S1014). When normalization is performed, the host 100 may acquire the same operation results as the results of sequentially performing GEMV, Softmax, and GEMV operations.

FIG. 12 is a flowchart illustrating a GEMM operation method of an operator according to an embodiment of the present invention.

Referring to FIG. 12, the controller 310 of the operator 300 stores data distributed by the host 100 in the internal memory 320 (operation S1102).

After operation S1102, the adder 342 of the operator 300 receives row-direction data and column-direction data from the data stored in the internal memory 320 through the controller 310 and adds the received data (operation S1104). At this time, the row-direction data and column-direction data may be data (values) selected according to an operation method predetermined at the time of designing the compiler.

After operation S1104, the multiplier 344 of the operator 300 receives the row-direction data from the data stored in the internal memory 320 through the controller 310 and multiplies the row-direction data by the output value of the adder 342 (operation S1106). At this time, the input row-direction data may be data (value) selected according to the operation method predetermined at the time of designing the compiler.

After operation S1106, the exponent operator and multiplier 346 of the operator 300 outputs an exponent for the output value of the multiplier 344, and performs a cumulative multiplication operation on the exponent output values (operation S1108). That is, the exponent operator and multiplier 346 includes a lookup table that outputs an exponent for the output value of the multiplier 344, so that an exponent operation can be performed on the output value of the multiplier 344.

As described above, according to the AI operation system and method according to some embodiments of the present invention, it is possible to convert the GEMV operation, which is inefficient to be performed in a systolic array, into the GEMM operation by merging the nodes of the attention layer consisting of GEMV, Softmax, and GEMV, thereby increasing the hourly resource usage.

According to the AI operation system and method according to some embodiments of the present invention, it is possible to enable GEMM to be performed in parallel by a plurality of operators by being divided into multiple independent GEMM operations in the conversion process, thereby maximizing the operation efficiency.

While the present invention has been described with reference to embodiments illustrated in the accompanying drawings, the embodiments should be considered in a descriptive sense only, and it should be understood by those skilled in the art that various alterations and other equivalent embodiments may be made. Therefore, the scope of the present invention should be defined by only the following claims.

What is claimed is:

1. An artificial intelligence (AI) operation system, comprising:
a plurality of operators; and
a host configured to merge nodes constituting a specific attention layer in a transformer model, pre-process specific matrix data among data of the merged node, distribute the preprocessed data and non-preprocessed data to the plurality of operators, and add and normalize operation results of the plurality of operators,
wherein the plurality of operators perform a GEneral Matrix Matrix Multiplication (GEMM) operation in parallel using the distributed data.

2. The AI operation system of claim 1, wherein the host merges the nodes constituting the attention layer consisting of GEneral Matrix Vector Multiplication (GEMV), Softmax, and GEMV into a single node.

3. The AI operation system of claim 1, wherein the data of the merged node includes at least one of query feature map data, key feature map data, and value feature map data.

4. The AI operation system of claim 3, wherein the host preprocesses the value feature map data among the data of the merged node.

5. The AI operation system of claim 4, wherein the host performs a logarithmic operation on each element of the value feature map data, and performs preprocessing by dividing a value obtained by performing the logarithmic operation by a sum of each element of the query feature map data.

6. The AI operation system of claim 1, further comprising:
a memory,
wherein the host stores the preprocessed data and the non-preprocessed data in the memory, and extracts data necessary for each operator from the memory and distributes the extracted data.

7. The AI operation system of claim 1, wherein the host divides a new operation generated by merging the nodes into independent operations, distributes the divided operations to the plurality of operators, and distributes data necessary for an operation to be performed by each operator among the preprocessed data and the non-preprocessed data, to each operator.

8. The AI operation system of claim 1, wherein each of the plurality of operators includes
an internal memory configured to store the distributed data,
a processing element array including a plurality of processing elements, and
a controller configured to control the operation of the processing element and data movement between the processing elements in response to a request from the host.

9. The AI operation system of claim 8, wherein the plurality of processing elements include
a plurality of adders configured to receive row-direction data and column-direction data among the data stored in the internal memory through the controller and adding the received data,
a plurality of multipliers configured to receive the row-direction data among the data stored in the internal memory through the controller and multiply the row-direction data by an output value of the plurality of adders, and
a plurality of exponent operators and multipliers configured to perform an exponent operation on an output value of the plurality of multipliers and perform a cumulative multiplication operation on exponent output values.

10. The AI operation system of claim 9, wherein each of the plurality of exponent operators and multipliers includes a lookup table outputting an exponent for the output value of each multiplier.

11. The AI operation system of claim 8, wherein the processing element array is based on a systolic array.

12. An AI operation system comprising:
a plurality of operators;
a host configured to merge nodes constituting a specific attention layer in a transformer model, preprocess specific matrix data among data of the merged nodes to convert GEMV into GEMM, distribute the preprocessed data and non-preprocessed data to the plurality of operators to perform GEMM in parallel in the plurality of operators, and add and normalize operation results of the plurality of operators; and
a memory configured to store the preprocessed data and the non-preprocessed data,
wherein each of the plurality of operators receives row/column-direction data based on the distributed data and performs an addition operation, receives row-direction data based on the distributed data and performs a multiplication operation on the received row-direction data and a value obtained by performing the addition operation, performs an exponent operation on a value obtained by performing the multiplication operation, and performs a GEMM operation in parallel by performing a cumulative multiplication operation on values obtained by performing the exponent operation.

13. The AI operation system of claim 12, wherein the host merges the nodes constituting the attention layer consisting of GEMV, Softmax, and GEMV, into a single node.

14. The AI operation system of claim 12, wherein the data of the merged node includes at least one of query feature map data, key feature map data, and value feature map data, and
the host performs a logarithmic operation on each element of the value feature map data among the data of the merged node, and performs preprocessing by dividing a value obtained by performing the logarithmic operation by a sum of each element of the query feature map data.

15. The AI operation system of claim 12, wherein each of the plurality of operators includes
an inner memory configured to store the distributed data;
a processing element array including a plurality of processing elements, and
a controller configured to control the operation of the processing element and data movement between the processing elements in response to a request from the host.

16. The AI operation system of claim 15, wherein the plurality of processing elements include
a plurality of adders configured to receive row-direction data and column-direction data among the data stored in the internal memory through the controller and adding the received data,
a plurality of multipliers configured to receive the row-direction data among the data stored in the internal memory through the controller and multiplying the row-direction data by an output value of the plurality of adders, and
a plurality of exponent operators and multipliers configured to perform an exponent operation on an output value of the plurality of multipliers and perform a cumulative multiplication operation on exponent output values.

17. An AI operation method comprising:
merging, by a host, nodes constituting a specific attention layer in a transformer model;
preprocessing, by the host, specific matrix data among data of the merged node;
distributing, by the host, the preprocessed data and non-preprocessed data to a plurality of operators;
performing, by the plurality of operators, a parallel operation using the distributed data; and
adding and normalizing, by the host, operation results of the plurality of operators.

18. The AI operation method of claim 17, wherein the merging of the nodes includes merging, by the host, the nodes constituting the attention layer consisting of GEMV, Softmax, and GEMV into a single node.

19. The AI operation method of claim 17, wherein the preprocessing of the specific matrix data includes performing, by the host, a logarithmic operation on each element of value feature map data among data of the merged node including at least one of query feature map data, key feature map data, and the value feature map data.

20. The AI operation method of claim 17, wherein the performing of the parallel operation includes
storing, by a controller of each operator, the distributed data in an inner memory,
receiving, by a plurality of adders of each operator, row-direction data and column-direction data among the data stored in the internal memory through the controller, and adding the received data,
receiving, by a plurality of multiplexers of each operator, the row-direction data among the data stored in the internal memory through the controller and multiplexing the row-direction data by an output value of the plurality of adders, and
performing, by a plurality of exponent operators and multipliers of each operator, an exponent operation on an output value of the plurality of multiplexers and performing a cumulative multiplication operation on exponent output values.
